(19) United States
(12) Patent Application Publication
(10) Pub. No.: US 2017/0097158 A1
(43) Pub. Date: Apr. 6, 2017

(54) Drop Bottom Charcoal Chimney

(71) Applicant: Joseph Charles Thompson, Denton County, TX (US)

(72) Inventor: Joseph Charles Thompson, Denton County, TX (US)

(21) Appl. No.: 14/875,029

(22) Filed: Oct. 5, 2015

(51) Int. Cl. F24B 15/00; A47J 37/07

(52) U.S. Cl. CPC F24B 15/005; A47J 37/079

(57) ABSTRACT

A charcoal starter device includes a cylindrical housing having an open top and an open bottom and a series of spaced apertures near the bottom. The charcoal starter device also has a handle and a hinged charcoal support plate located inside the cylindrical housing just below the handle and having spaced apertures. The hinge is located on the opposite side of the cylindrical housing from the handle. A pull knob is located below the handle, and a support bar for supporting the edge of the charcoal support plate opposite the hinge is affixed to the pull knob. The support bar can be pulled back from the support position by a user pulling the pull knob releasing any charcoal and a spring returns the support bar to the support position under the edge of the hinged charcoal support plate after the support plate has been returned to the support position and the pull knob has been released.

### CROSS-REFERENCE TO RELATED APPLICATIONS

None

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The field of the invention is charcoal starter devices also known as charcoal chimneys, and in particular for drop bottom charcoal chimneys.

2. Description of Related Art

### BRIEF SUMMARY OF THE INVENTION

A charcoal starter device, sometimes referred to as a charcoal chimney, includes a cylindrical housing having an outer surface and an inner surface, the cylindrical housing having an open top and an open bottom and a series of spaced apertures near the bottom. The charcoal starter device also has a handle affixed to the outer surface of the cylindrical housing, and a hinged charcoal support plate located inside the cylindrical housing just below the handle and having spaced apertures. The hinge is located on the opposite side of the cylindrical housing from the handle. A pull knob is located below the handle, and a support bar for supporting the edge of the charcoal support plate opposite the hinge is affixed to the pull knob. The cylindrical housing has an aperture for the support bar to reach below the edge of the hinged charcoal support plate. The support bar can be pulled back from the support position by a user pulling the pull knob and a spring on the support bar outside of the cylindrical housing pushes against the pull knob to return the support bar to the support position under the edge of the hinged charcoal support plate after the support plate has been returned to the support position and the pull knob has been released. The handle and the pull knob, both include a thermally insulating material, such as wood.

A shield between the handle and the cylindrical housing protects a user from the heat of the cylindrical housing when charcoal is burning in the charcoal starter device.

In a preferred form, the series of spaced apertures near the bottom of the cylindrical housing is located below the supported position of the hinged charcoal support plate. In this way, the charcoal starter device can be placed on a solid surface, thus cutting off the open bottom of the cylindrical housing and still get airflow up through the charcoal and out the open top of the cylindrical housing.

It can now be seen that a method for using a charcoal starter device includes the steps of placing charcoal inside a cylindrical housing having an outer surface and an inner surface, an open top and an open bottom and on a hinged support plate within the cylindrical housing, the hinged support plate having spaced apertures for airflow, but wherein the apertures are too small to allow normal sized charcoal to pass through an aperture. The next step is to light the charcoal so that the charcoal burns inside the cylindrical housing and on the support plate, followed by lifting the cylindrical housing including the hinged charcoal support plate and the burning charcoal by means of a handle affixed to the outer surface of cylindrical housing, where in the handle is located on the opposite side of the cylindrical housing from the hinge of the hinged charcoal support plate. The final steps are moving the charcoal starter device to a position above the desired location for the burning charcoal, and pulling a pull knob located below the handle releasing the burning charcoal in the desired location, wherein the pull knob is affixed to a support bar for supporting the edge of the hinged charcoal support plate opposite the hinge.

The method for using a charcoal starter device can also include the steps of turning the charcoal starter device upside down by means of the handle once all of the burning charcoal has been released, letting the charcoal support plate fall past the support position, releasing pull knob and turning the charcoal starter device right side up.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a back elevation view of a charcoal starter device in a closed position according to the present invention;

FIG. 2 is a sectional view of the charcoal starter device taken along line 2-2 of FIG. 1;

FIG. 3 is a back view of the charcoal starter device of FIG. 1 in an open position; and

FIG. 4 is a sectional view of the charcoal starter device taken along line 4-4 of FIG. 3.

### DETAILED DESCRIPTION OF THE INVENTION

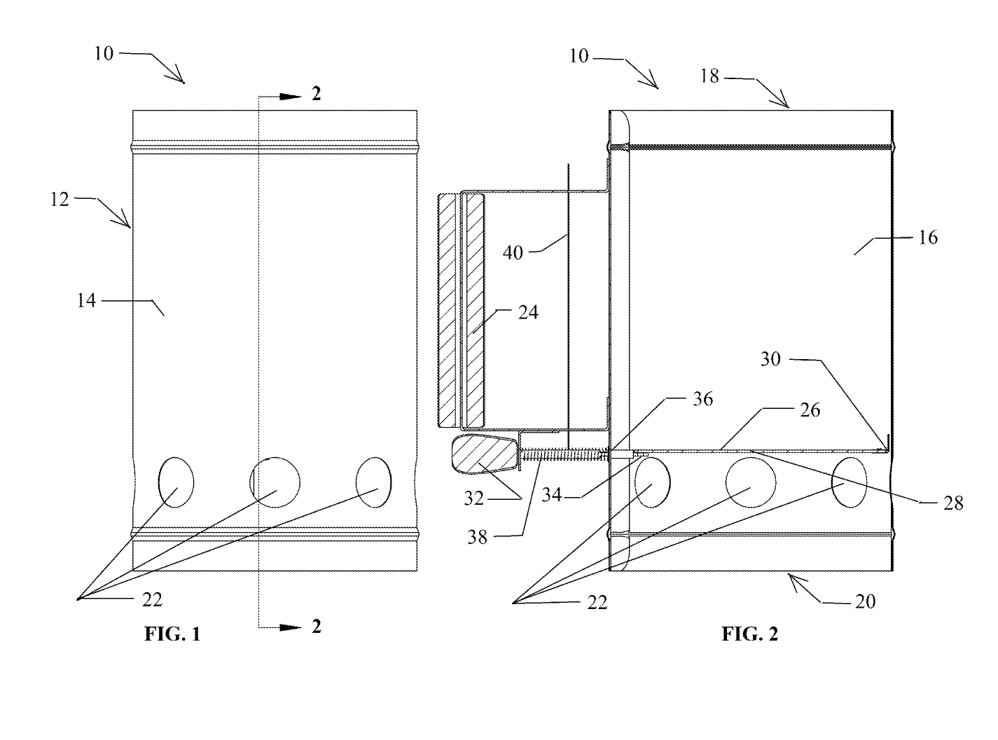

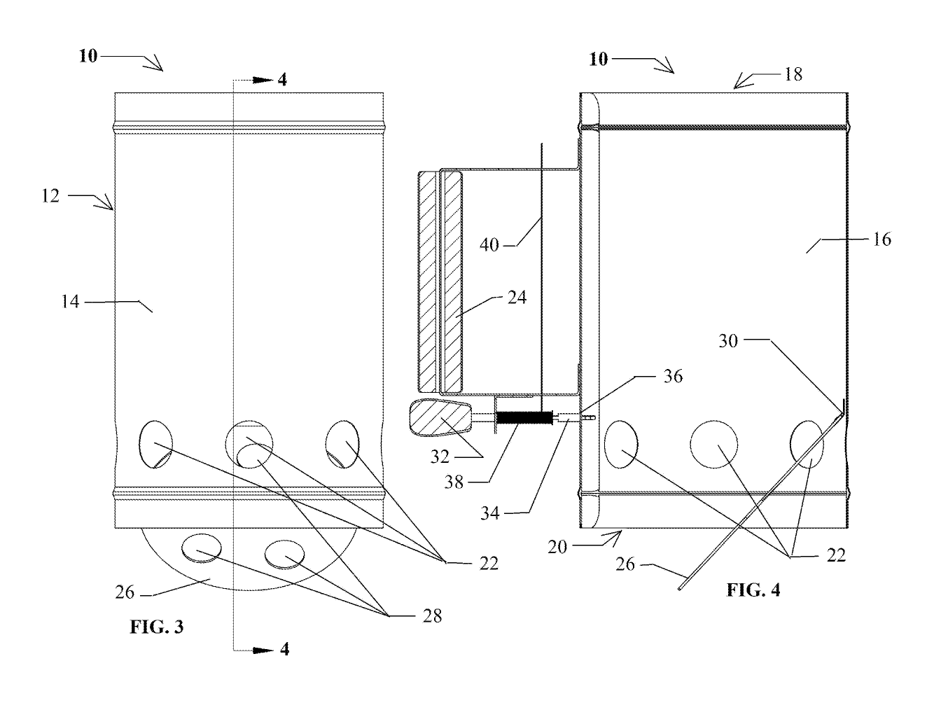

Referring now to the drawing, and in particular to FIG. 1 and FIG. 2, a charcoal starter device, sometimes referred to as a charcoal chimney, is referred to generally by reference numeral 10. A cylindrical housing 12 has an outer surface 14 and an inner surface 16, the cylindrical housing having an open top 18 and an open bottom 20 and a series of spaced apertures 22 near the bottom. A handle 24 is affixed to outer surface 14 of cylindrical housing 12, and a hinged charcoal support plate 26 located inside the cylindrical housing just below the handle and having spaced apertures 28. The hinge 30 is located on the opposite side of the cylindrical housing from handle 24. A pull knob 32 is located below handle 24, and a support bar 34 for supporting the edge of charcoal support plate 26 opposite the hinge is affixed to the pull knob. The cylindrical housing has an aperture 36 for the support bar to reach below the edge of the hinged charcoal support plate. Now referring also to FIG. 3 and FIG. 4, support bar 34 can be pulled back from the support position by a user pulling pull knob 32, removing the support from the side of charcoal support plate opposite the hinge so that the charcoal falls through the open bottom of the cylindrical housing. A spring 38 on the support bar outside of the cylindrical housing pushes against the pull knob to return the support bar to the support position under the edge of the hinged charcoal support plate after the support plate has been returned to the support position and the pull knob has been released. The handle and the pull knob, both include a thermally insulating material, such as wood.

A shield 40 between handle 24 and cylindrical housing 12 protects a user from the heat of the cylindrical housing when charcoal is burning in the charcoal starter device.

In a preferred form, series of spaced apertures 22 near the bottom of the cylindrical housing is located below the supported position of the hinged charcoal support plate. In this way, the charcoal starter device can be placed on a solid surface, thus cutting off the open bottom of the cylindrical housing and still get airflow up through the charcoal and out the open top of the cylindrical housing.

It can now be seen that a method for using a charcoal starter device includes the steps of placing charcoal inside a cylindrical housing having an outer surface and an inner surface, an open top and an open bottom and on a hinged support plate within the cylindrical housing, the hinged support plate having spaced apertures for airflow, but wherein the apertures are too small to allow normal sized charcoal to pass through an aperture. The next step is to light the charcoal so that the charcoal burns inside the cylindrical housing and on the support plate, followed by lifting the cylindrical housing including the hinged charcoal support plate and the burning charcoal by means of a handle affixed to the outer surface of cylindrical housing, where in the handle is located on the opposite side of the cylindrical housing from the hinge of the hinged charcoal support plate. The final steps are moving the charcoal starter device to a position above the desired location for the burning charcoal, and pulling a pull knob located below the handle releasing the burning charcoal in the desired location, wherein the pull knob is affixed to a support bar for supporting the edge of the hinged charcoal support plate opposite the hinge.

The method for using a charcoal starter device can also include the steps of turning the charcoal starter device upside down by means of the handle once all of the burning charcoal has been released, letting the charcoal support plate fall past the support position, releasing pull knob and turning the charcoal starter device right side up.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A charcoal starter device comprising:
a cylindrical housing having an outer surface and an inner surface, the cylindrical housing having an open top and an open bottom and a series of spaced apertures near the bottom;
a handle affixed to the outer surface of the cylindrical housing;
a hinged charcoal support plate located inside the cylindrical housing just below the handle and having spaced apertures, wherein the hinge is located on the opposite side of the cylindrical housing from the handle;
a pull knob located below the handle;
a support bar for supporting the edge of the charcoal support plate opposite the hinge, wherein the support bar is affixed to the pull knob and the cylindrical housing has an aperture for the support bar to reach below the edge of the hinged charcoal support plate and wherein the support bar can be pulled back from the support position by a user pulling the pull knob, removing the support from the side of charcoal support plate opposite the hinge whereby the charcoal falls through the open bottom of the cylindrical housing; and
a spring on the support bar outside of the cylindrical housing and pushing against the pull knob to return the support bar to the support position under the edge of the hinged charcoal support plate after the support plate has been returned to the support position and the pull knob has been released.

2. A charcoal starter device according to claim 1, further comprising a shield between the handle and the cylindrical housing to protect a user from the heat of the cylindrical housing when charcoal is burning in the charcoal starter device.

3. A charcoal starter device according to claim 2, wherein the handle comprises a thermally insulating material and wherein the pull knob comprises a thermally insulating material.

4. A charcoal starter device according to claim 3, wherein the thermally insulating material for both the handle and the pull knob is wood.

5. A charcoal starter device according to claim 1, wherein the series of spaced apertures near the bottom of the cylindrical housing is located below the supported position of the hinged charcoal support plate.

6. A charcoal starter device according to claim 5, further comprising a shield between the handle and the cylindrical housing to protect a user from the heat of the cylindrical housing when charcoal is burning in the charcoal starter device.

7. A charcoal starter device according to claim 6, wherein the handle comprises a thermally insulating material and wherein the pull knob comprises a thermally insulating material.

8. A charcoal starter device according to claim 7, wherein the thermally insulating material for both the handle and the pull knob is wood.

9. A method for using a charcoal starter device, comprising the steps of:
placing charcoal inside a cylindrical housing having an outer surface and an inner surface, an open top and an open bottom and on a hinged support plate having spaced apertures for airflow, but wherein the apertures are too small to allow normal sized charcoal to pass through an aperture;
lighting the charcoal so that the charcoal burns inside the cylindrical housing and on the support plate;
lifting the cylindrical housing including the hinged charcoal support plate and the burning charcoal by means of a handle affixed to the outer surface of cylindrical housing, where in the handle is located on the opposite side of the cylindrical housing from the hinge of the hinged charcoal support plate;
moving the charcoal starter device to a position above the desired location for the burning charcoal, and
pulling a pull knob located below the handle releasing the burning charcoal in the desired location, wherein the pull knob is affixed to a support bar for supporting the edge of the hinged charcoal support plate opposite the hinge, wherein the cylindrical housing has an aperture for the support bar to reach below the edge of the hinged charcoal support plate and wherein the support bar can be pulled back from the support position by pulling the pull knob and wherein a spring on the support bar outside of the cylindrical housing and pushing against the pull knob returns the support bar to the support position under the edge of the hinged charcoal support plate after the support plate has been returned to the support position and the pull knob has been released.

10. A method for using a charcoal starter device, further comprising the steps of:
turning the charcoal starter device upside down by means of the handle once all of the burning charcoal has been released;
letting the charcoal support plate fall past the support position;
releasing pull knob; and
turning the charcoal starter device right side up.
